(19) United States
(12) Patent Application Publication
(10) Pub. No.: US 2013/0112516 A1
(43) Pub. Date: May 9, 2013

(54) ANGLE ADJUSTING DEVICE FOR A BRAKE BLOCK

(71) Applicant: Wayne-Ian Moore, Changhua County (TW)

(72) Inventor: Wayne-Ian Moore, Changhua County (TW)

(21) Appl. No.: 13/629,611

(22) Filed: Sep. 28, 2012

(30) Foreign Application Priority Data
Nov. 9, 2011 (TW) 100221138

(51) Int. Cl. F16D 65/092; B62L 1/10

(52) U.S. Cl. 188/234

(57) ABSTRACT

An angle adjusting device for a brake block includes a brake block, a ball and a screw. The brake block has a socket and a through hole defined therein. The ball is rotatably disposed in the socket. The ball has a screw hole corresponding to the through hole. The screw is passed through the through hole of the brake block and is screwed into the screw hole of the ball so that the brake block is mountable on a brake system. The brake block could be pivotally rotated by a connection between the ball and the socket of the brake block, so that a frictional effect of the brake block which contacts with a wheel rim of a bicycle is increased.

### BACKGROUND OF THE INVENTION

1. Field of the Invention

The present invention relates to a brake block for a bicycle, and more particularly to an angle adjusting device for a brake block.

2. Description of Related Art

Bicycle activity is more and more popular in these days because bicycle activity is eco-friendly, convenient and entertaining. Many enterprises encourage their employees to go to work by bicycles instead of driving vehicles today. Many people also go shopping or go traveling by bicycles during their leisure time. Because a brake block of a bicycle is very important for the safety of riding, the improvement of the brake block device is progressed.

The conventional brake block for a bicycle comprises a brake block, a holder and a positioning rod. The brake block is formed on the holder integrally. The positioning rod has a square head defined at one end thereof. The holder has a fixing hole corresponding to the square head of the positioning rod. The positioning rod is connected to the fixing hole of the holder via the square head of the positioning rod, so that the brake block is positioned on the positioning rod stably. Furthermore, a braking surface of the brake block is inclined. Therefore, the frictional effect of the braking surface of the brake block which contacts with a wheel rim of a bicycle is progressed. However, the conventional structure of brake block cannot fully improve the contact efficiency to the wheel rim.

The present invention has arisen to mitigate and/or obviate the disadvantages of the conventional.

### SUMMARY OF THE INVENTION

The main objective of the present invention is to provide an improved angle adjusting device for a brake block.

To achieve the objective, an angle adjusting device for a brake block comprises a brake block, a ball and a screw, the brake block having a socket and a through hole defined therein, the through hole communicating with the socket, the ball disposed in the socket, and an inner wall of the socket covering the ball so that the ball is rotatable in the socket, the ball having a screw hole corresponding to the through hole, and the screw passed through the through hole of the brake block and screwed into the screw hole of the ball, so that the brake block is mountable on a brake system. Wherein, a thin film is coated on a surface of the ball; the thin film could be made of metal materials or non-metal materials; a holder is connected to the brake block, the holder having a fixing hole corresponding to the through hole, the screw passed through the fixing hole and the through hole and screwed into the screw hole securely to avoid the screw being loosened; a plurality of washers is disposed between the screw and the holder, the screw passed through the washers, so that the brake blocks is mounted on a brake calipers securely.

Under this arrangement, when the brake block is mounted on the brake system via the screw, the brake block is pivotally rotated relative to an axial axis of the screw by a connection between the ball and the socket of the brake block, so that the brake block is fully contacted with a wheel rim; therefore, a brake efficiency of the brake block 1 is increased.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of an angle adjusting device for a brake block of the present invention;

FIG. 2 is a perspective view of the angle adjusting device for a brake block;

FIG. 3 is a cross-sectional view of the angle adjusting device for a brake block;

FIG. 4 is an assembled view for showing the angle adjusting device for a brake block which is assembled to a brake system;

FIG. 5 is a schematic view for showing the angle adjusting device for a brake block which is assembled to the brake system with a wheel rim; and

FIG. 6 is a schematic view for showing the angle adjusting device for a brake block which is assembled to the brake system with another wheel rim.

### DETAILED DESCRIPTION OF THE INVENTION

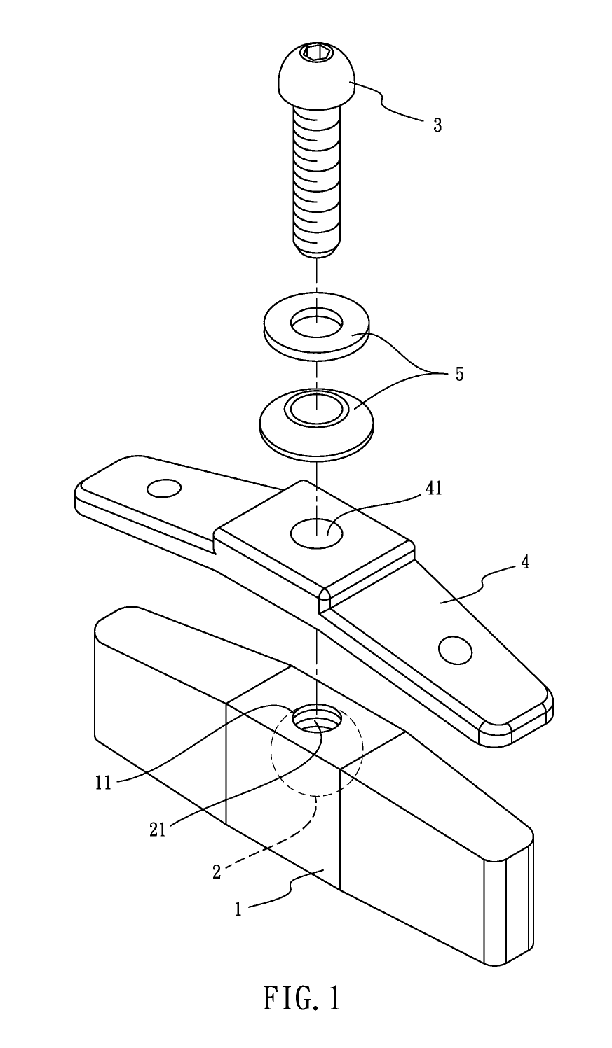

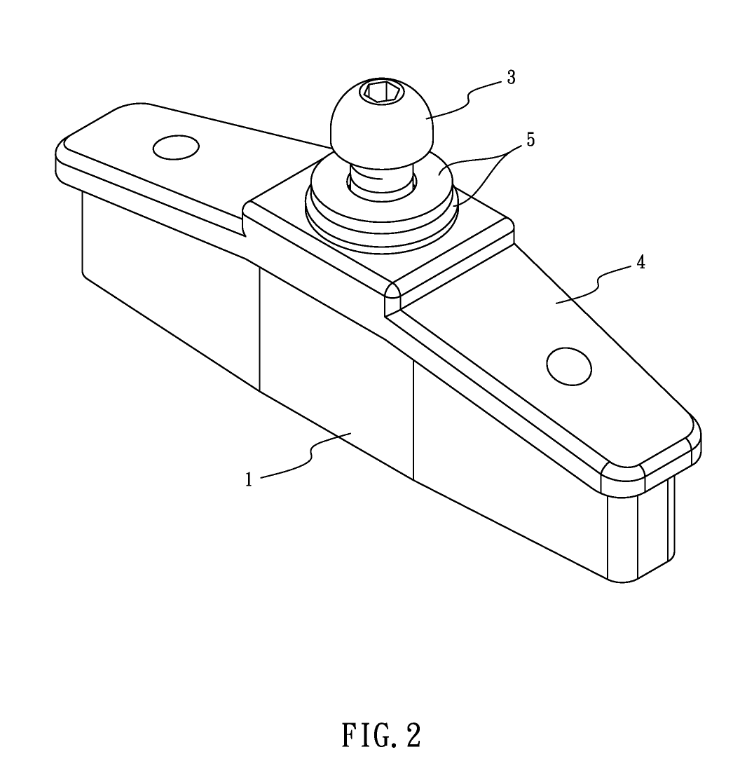

Referring to FIGS. 1-3, an angle adjusting device for a brake block in accordance with the present invention comprises a brake block 1, a ball 2 and a screw 3.

The brake block 1 has a socket 12 and a through hole 11 defined therein. The through hole 11 communicates with the socket 12.

The ball 2 is disposed in the socket 12, and an inner wall of the socket 12 covers the ball 2 so that the ball 2 is rotatable in the socket 12. The ball 2 has a screw hole 21 corresponding to the through hole 11.

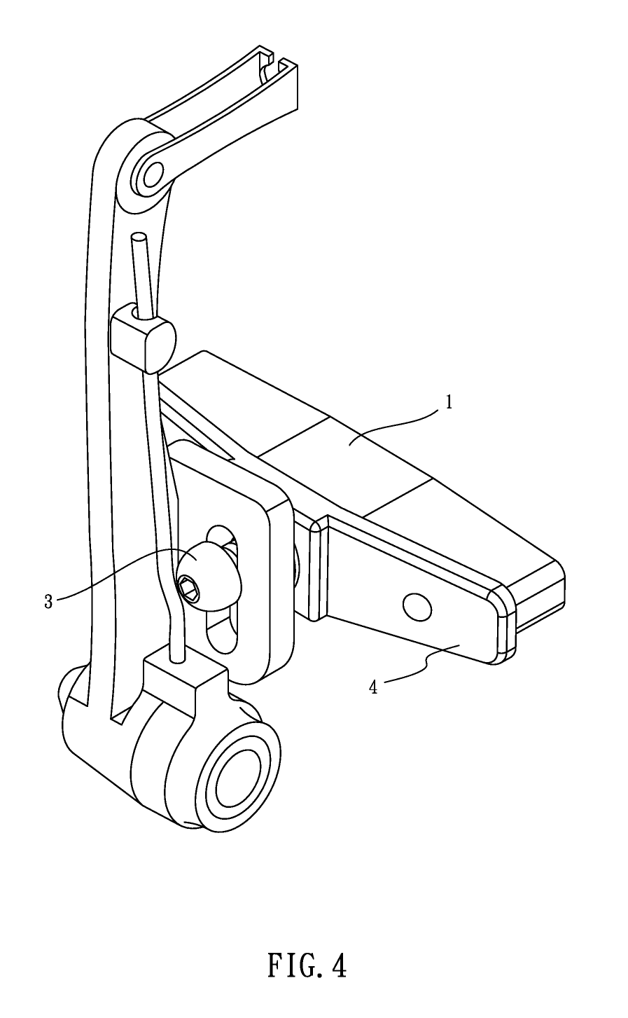

The screw 3 is passed through the through hole 11 of the brake block 1; and then is screwed into the screw hole 21 of the ball 2; as a result, the brake block 1 is mountable on a brake system (as shown in FIG. 4).

Under this arrangement, when the brake block 1 is mounted on the brake system via the screw 3, the brake block 1 is pivotally rotated relative to an axial axis of the screw 3 by a connection between the ball 2 and the socket 12 of the brake block 1. Thereby, a position angle between the axial axis of the screw 3 and a plane of the brake block 1 is adjustable, so that the brake block 1 is fully contacted with a wheel rim. Therefore a brake efficiency of the brake block 1 is increased.

Referring to FIG. 1, which further shows that a holder 4 being connected to the brake block 1. The holder 4 has a fixing hole 41 corresponding to the through hole 11. The screw 3 is passed through the fixing hole 41 and the through hole 11, and then is screwed into the screw hole 21 securely to avoid the screw 3 being loosened after long-term use of the brake block 1.

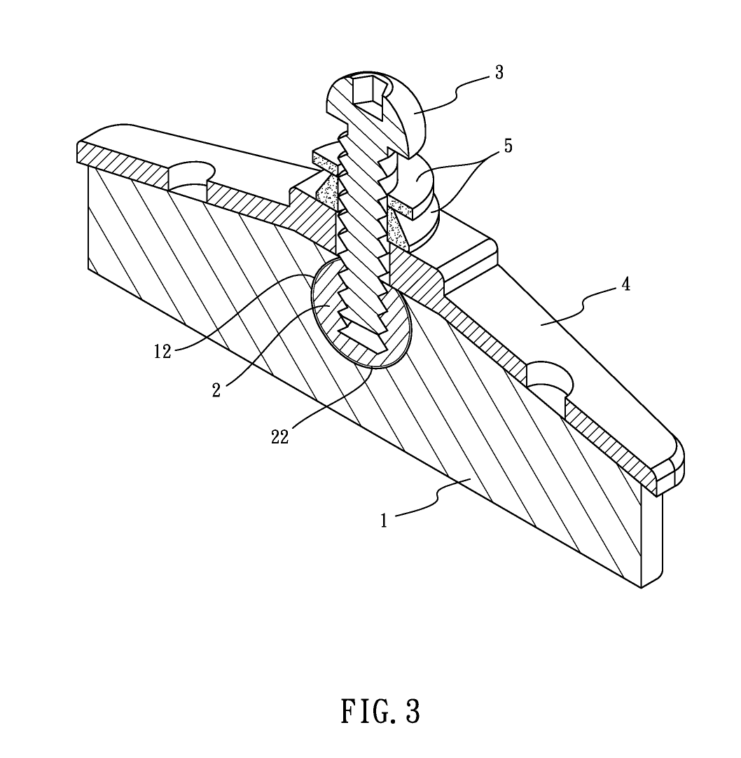

Referring to FIG. 3, a thin film 22 is coated on a surface of the ball 2. The thin film 22 could be made of metal materials or non-metal materials.

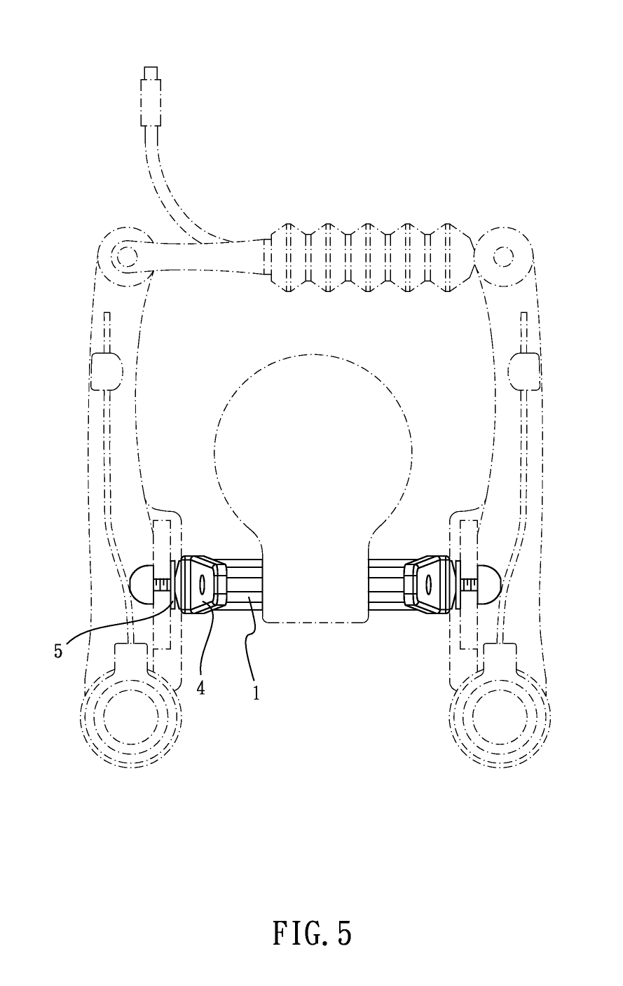

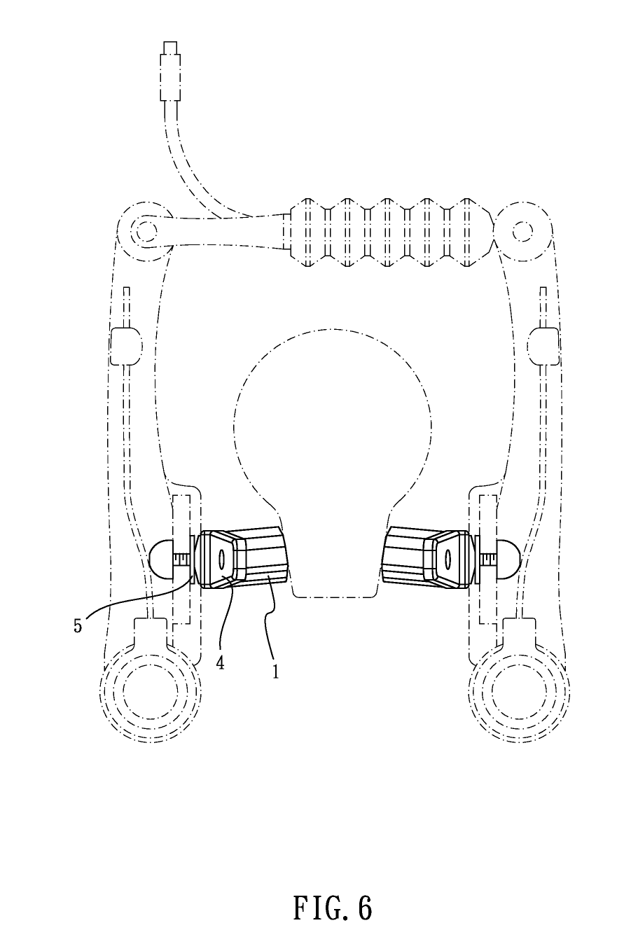

Referring to FIGS. 4-6, a plurality of washers 5 is disposed between the screw 3 and the holder 4. The screw 3 is passed through the washers 5, so that the brake blocks 1 is mounted on a brake calipers securely (as shown in FIG. 4), and the brake block 1 could swing within a range of said angle.

Although the invention has been explained in relation to its preferred embodiment, it is to be understood that many other possible modifications and variations can be made without departing from the spirit and scope of the invention as hereinafter claimed.

What is claimed is:

1. An angle adjusting device for a brake block comprising:
a brake block, a ball and a screw;
the brake block having a socket and a through hole defined therein, the through hole communicating with the socket;
the ball disposed in the socket, and an inner wall of the socket covering the ball so that the ball is rotatable in the socket; the ball having a screw hole corresponding to the through hole; and
the screw passed through the through hole of the brake block and screwed into the screw hole of the ball, so that the brake block is mountable on a brake system;
wherein the brake block is pivotally rotated relative to an axial axis of the screw by a connection between the ball and the socket of the brake block, so that the brake block is fully contacted with a wheel rim; therefore, a brake efficiency of the brake block is increased.

2. The angle adjusting device for a brake block as claimed in claim 1, wherein a thin film is coated on a surface of the ball.

3. The angle adjusting device for a brake block as claimed in claim 2, wherein the thin film could be made of metal materials or non-metal materials.

4. The angle adjusting device for a brake block as claimed in claim 1, wherein a holder is connected to the brake block, the holder having a fixing hole corresponding to the through hole, the screw passed through the fixing hole and the through hole and screwed into the screw hole securely to avoid the screw being loosened.

5. The angle adjusting device for a brake block as claimed in claim 4, wherein a plurality of washers is disposed between the screw and the holder, the screw passed through the washers, so that the brake blocks is mounted on a brake calipers securely.
